(19) United States
(12) Patent Application Publication
(10) Pub. No.: US 2008/0193754 A1
(43) Pub. Date: Aug. 14, 2008

(54) Method and Device for Producing Bent Glass Bodies, and Glass Body Produced by the Method

(75) Inventor: Martin Cramer, Wiesbaden (DE)

Correspondence Address: LERNER GREENBERG STEMER LLP, P O BOX 2480, HOLLYWOOD, FL, 33022-2480, US

(73) Assignee: Schott AG, Mainz (DE)

(21) Appl. No.: 12/017,590

(22) Filed: Jan. 22, 2008

Related U.S. Application Data
(63) Continuation of application No. PCT/DE2006/001275, filed on Jul. 21, 2006.

(30) Foreign Application Priority Data
Jul. 22, 2005 (DE) 10 2005 034 962.5
Oct. 18, 2005 (DE) 10 2005 050 093.5

(51) Int. Cl. C03B 37/15; C03B 35/20; C03B 37/07; B32B 17/00

(52) U.S. Cl. 428/378; 65/377; 65/384; 65/382; 65/488; 428/364; 428/401; 428/375; 428/409

(57) ABSTRACT

A glass body with at least one curve is formed from a glass blank in bar form in a bending device for bending the glass blanks. The bending device has grippers which are movable in relation to one another. The glass blank is taken up by the grippers and clamped. Subsequently, the bending region between the grippers is heated up to a bending temperature by heating means. After that, the grippers are moved in a predetermined way, the bending region being freely bent. The advantageous effects of the invention are seen as being that any desired curves can be produced on glass blanks without requiring moulds that rely on pressing or contact. The free bending takes place without touching the surface in the heated-up bending region, so that instances of damage to the surface are avoided. This allows curved glass bodies with good optical properties to be produced.

### CROSS-REFERENCE TO RELATED APPLICATIONS

This is a continuation, under 35 U.S.C. § 120, of copending international application No. PCT/DE2006/001275, filed Jul. 21, 2006, which designated the United States; this application also claims the priority, under 35 U.S.C. § 119, of German patent application No. DE 10 2005 034 962.5 and German patent application No. DE 10 2005 050 093.5, respectively filed Jul. 22, 2005 and Oct. 18, 2005; the prior applications are herewith incorporated by reference in their entirety.

### BACKGROUND OF THE INVENTION

### Field of the Invention

The invention relates to a method for producing a glass body provided with at least one bend from a rod-shaped glass blank, a bending device for bending glass blanks, a bent glass body that is produced from a rod-shaped glass blank by way of the novel method, and uses of the bent glass body.

Bent glass bodies are preferably used in automotive engineering as an alternative to conventional combinations of signaling light generators with reflectors, for example as parking light ring, side light, cockpit illumination or the like. For example, such glass bodies are also used in appliances for the household or for industry as marker illumination, room lighting or indirect interior illumination.

Bent glass bodies of such type are produced from elongated rod-shaped glass blanks comprising multifiber systems or whole glass/solid glass systems. In this case, the glass blanks are substantially round as a rule in cross section perpendicular to the longitudinal axis. Other basic shapes are likewise considered; as such, elliptical and polygonal basic shapes are possible.

After production, the glass bodies have a bend lying substantially in a plane in at least one subsection. In the case of various sections of the same glass body, the bends can lie in different planes.

On the one hand, it is possible to incorporate simple angles on the glass blank. On the other hand, multiply bent glass bodies can be produced by bending the glass blanks once or several times.

Two methods are known for this purpose in the prior art. The first method is a deformation method on which the glass blanks heated to the deformation temperature are pressed into a mold. In another method, glass blanks heated to deformation temperature are drawn via a mold. The molds mostly consist of carbonaceous material.

These methods have substantial disadvantages for specific applications. Firstly, the costs of the molds cannot be neglected, since the molds undergo wear and must be exchanged at intervals in time. Moreover, there is generally a need for different molds for the various bends that are to be incorporated on the glass body. The outlay for producing a glass body having a plurality of different bends is therefore substantial in accordance with the method of the prior art, both as regards the processing period and as regards the production molds, and this results in high costs for the bent glass bodies.

Moreover, the known methods have the disadvantage that the surface of a glass blank brought to bending temperature can be damaged upon making contact with the mold wall during the molding operation such that the glass bodies thus shaped frequently have defects on their surface. Surfaces damaged in such a way have the effect that such glass bodies generally have poor optical properties, and their use as light guides is possible only in a restricted fashion. In particular, when optical transmission efficiency is important for the glass bodies, bent glass bodies produced by the methods of the prior art are not suitable, since surface defects lead to scattered radiation, thus substantially reducing the transmission efficiency.

It has also emerged that glass bodies made from bonded multifiber systems such as are used in the case of mold bending are unsuitable for various applications with regard to thermal stability and chemical durability, since the surface quality and thus also the optical properties are substantially worsened permanently owing to ambient or cleaning chemicals and to a changing ambient temperature.

### SUMMARY OF THE INVENTION

It is accordingly an object of the invention to provide a method and device for producing bent glass bodies which overcome the above-mentioned disadvantages of the heretofore-known devices and methods of this general type and which make available an improved method with the aid of which it is possible to produce bent glass bodies cost effectively and with good quality. Furthermore, it is an object of the invention to provide a bending device with the aid of which the novel method can be carried out. Moreover, it is an object of the invention to make available a bent glass body that has optimum optical properties, in particular high transmission efficiency as well as thermal stability and chemical durability, and that it is provided with an outstanding surface quality as well as various uses of the inventive glass body. In particular, the production costs of the glass body are also to remain low.

With the foregoing and other objects in view there is provided, in accordance with the invention, a method for producing a glass body with at least one bend from a rod-shaped glass blank, the method which comprises the following automated method steps:

holding the glass blank in a bending device having at least two grippers mounted to be movable relative to one another, and clamping the glass blank with the grippers;

positioning the glass blank with a designated bending region L₀ between the first and second grippers;

heating the bending region L₀ to a bending temperature with heating means; and

subsequently freely bending the bending region L₀ by way of a mutual bending movement of the grippers.

In other words, the method according to the invention is automated to perform the following: a) the glass blank is held in a bending device having at least two mutually movable grippers, and is clamped by the grippers; b) the glass blank is positioned such that a bending region L₀ envisaged for a bend is arranged between a first and a second gripper; c) the bending region L₀ is heated up to bending temperature by heating means, and subsequently d) the bending region L₀ is freely bent by a mutual bending movement of the grippers.

In accordance with the method, a rod-shaped glass blank is clamped by the grippers on the bending device. The grippers are positioned in this case on the glass blank such that the bending region L₀ envisaged for the bend is arranged between the grippers. The gripper positions preferably have a spacing on both sides from the bending region L₀. In this case, the grippers are positioned such that during the bending operation the clamping sites on the glass blank are substantially free from a rising temperature owing to being heated up.

The grippers secure the rod-shaped glass blank in such a way that the surface of the glass remains free from damage. To this end, the grippers, which can be made from metal, preferably have a special coating made from materials that are kind to the glass surfaces during bending. The invention also encompasses grippers that consist of appropriate materials that are gentle to glass surfaces. Thus, appropriate plastics, composite materials and/or types of rubber are provided as gripper materials.

After the rod-shaped glass blank has been positioned for the bending operation, it is positioned at the heating means. To this end, the glass blank can be moved by the grippers to the heating means in order to heat up the bending region. According to the invention, it is likewise provided to guide the heating means up to the glass blank and heat up the bending region there correspondingly.

After a specific heating period, heating means and glass blank are separated again so that sufficient freedom of movement is present for the bending. Subsequently, the glass blank is freely bent via a mutual bending movement of the grippers in the bending region. This means that the heated up bending region of the glass blank, on which the surface could be damaged particularly easily in the hot state, advantageously remains free from being touched during the bending operation.

According to the invention, the method is computer controlled. This means that all the movements of the grippers and of the heating means, as well as the temporal stipulations of the method steps are prescribed by an appropriate data processing unit. In this case, the data processing unit particularly controls the movement drives of the bending device. However, the heating up time and the bending rate are also set.

Once the bending region has been adequately heated up and the optimum bending temperature has been reached, the data processing unit produces a mutual bending movement of the grippers, and the glass blank is clamped in accordance with the stipulations.

An inventive development of the method is provided by virtue of the fact that during bending the glass blank is secured relative to the bending device at one end of the bending region by a first gripper, and the bending movement is executed by a second gripper acting at the opposite end of the bending region.

It is therefore provided according to the invention that at least one of the two grippers that are required for producing a bend can be moved. The respective other gripper can, by contrast, be arranged in a stationary fashion on the bending device.

Depending on which bending movement a bending operation comprises, it can also be necessary or expedient to move the two grippers independently of one another. The scope of the invention therefore likewise covers the possibility of moving the two grippers independently of one another. Owing to this method variant, it is advantageously possible to make more degrees of freedom available during the bending operation.

The invention further provides that the bending movement describes a bend path in order to produce the envisaged bend on the glass blank, and that the bend path comprises a bending curve and an offset value for length compensation on the glass blank for each of the grippers respectively.

In order to produce the envisaged bend on the glass blank by a suitable bending movement of the grippers, it is necessary for the bending movement of the grippers to describe a bending curve. In this case the bending curve is prescribed starting from the initial point of the clamping sites, and comprises the path that is covered by one clamping site in relation to the respective other clamping site.

In the case when one clamping site is permanently arranged on the bending device, the bending curve is prescribed by the initial point of the clamping site moved for the bend. The bending curve is calculated in accordance with specific parameters by the data processing unit, and the grippers are correspondingly controlled.

It has been realized in this case that the bending movement required for the bend must deviate from the bending curve in order to produce the bend optimally. The bending movement according to which the gripper moves during the bending operation therefore deviates from the bending curve and an offset value is superposed on it. This offset value is dependent on the bending angle produced respectively, and is added to the bending curve by the data processing unit.

The bending operation can thus advantageously be adapted to the properties of the glass materials respectively used. Any desired bend can be incorporated on the glass blank with the aid of the inventive method. The deformation of the glass blank is therefore performed in a way such that pressing molds or other molds can be completely dispensed with, it thereby being possible to produce the bent glass bodies cost effectively and without damaging the surface of the glass body.

According to the invention the method is supplemented by virtue of the fact that a plurality of bends are freely bent simultaneously on one glass blank in an arrangement of the bending device having more than two corresponding grippers and heating means.

In this method variant, the glass blank can be processed simultaneously at a plurality of sites, a plurality of grippers acting at different clamping sites of the glass blank. A corresponding number of heating means is provided in order to heat their respective bending regions up to bending temperature, the envisaged bends subsequently being produced by the grippers through the corresponding movements. It is thereby possible to substantially reduce the processing period for a bent glass body, since the glass blanks need to be set up or positioned in the bending device simultaneously only once for a plurality of bending operations.

In a development of the inventive method, it is provided that a plurality of bends are freely bent in temporally sequential bending operations on a glass blank in an arrangement of the bending device, and in that the grippers are repositioned at the next respective bending region after each finished bending operation.

The bends are thereby incorporated on the glass blank one after another. In this case the grippers respectively grip around a bending region, whereupon the heating means heat the latter up to the prescribed bending temperature, and the grippers then bend the glass blank on the prescribed bend path by means of the bending movement. Subsequently, the grippers are repositioned around the next bending region, and the bending operation is continued in accordance with the invention. It is possible in this way to produce glass bodies with very complex shapes, it being possible for any desired bending angles to be incorporated on the glass blank in various directions and/or planes.

The grippers can be used to grip very close to the bending region such that the bends can follow one another on the glass body at small spacings.

It is provided in this case, in accordance with the invention that, during bending the bending curve of the gripper(s) is prescribed as a function depending on the straight length of the bending region L₀, the final bending angle α_{E} to be reached, and/or the bending radius to be reached.

The bending angle α_{N} respectively to be produced is advantageously calculated iteratively in this case by the data processing unit and prescribed for controlling the movement drives of the gripper(s) for the envisaged bend path.

It is, furthermore, provided that the glass blank is heated up to a prescribed bending temperature during a prescribed heating period and preferably as a function of the glass volume to be heated and/or of the rod diameter.

It is thereby possible for the heating up time to be set individually. It is therefore advantageously possible to take account of special features of the glass composition and/or the dimensioning of the glass blank.

A development of the method is provided by virtue of the fact that the heating period and/or the bending temperature are/is prescribed by the data processing unit as a function of the glass material and diameter of the glass blank.

Once the bending temperature required for the deformation of the glass blank is reached, the bend path can be prescribed in a fashion independent of the heating period and/or of the bending temperature.

It is advantageously provided that the grippers act on the glass blank at a mutual spacing of length L_{G}>L₀.

It is thereby possible for the grippers to act at an adequate spacing from the envisaged bending region. Depending on the type of glass, the temperature gradient in the glass is very steep, and so the spacing can be selected to be correspondingly slight. It is thereby possible for bends to be incorporated at spacings following hard on one another. Multifarious shapes can thereby be incorporated on the glass blank, and bent glass bodies having very individual shapes can thereby be produced.

Moreover, it is advantageously provided that in order to bend them the glass blanks are successively removed by the grippers from a feeding apparatus, or are continuously introduced into the bending device.

One method variant provides in this case that the glass blanks are made available in a feeding apparatus, and the grippers grip the individual glass blanks in the feeding apparatus for each production operation. In this case, the positioning can already be performed during gripping of the glass blanks in the feeding apparatus, and so there is no longer a subsequent need for any separate positioning, or the positioning is performed firstly in the bending device. It has proved advantageous with this method variant that the glass blanks are gripped in a particularly gentle way for the glass surface, and so damage can largely be completely ruled out when producing the glass bodies. It is therefore possible to make available glass bodies having a high surface quality.

In the alternative method variant, the glass blanks are fed to the bending device continuously. In this case the glass blanks can be pushed on appropriate transport means between the open grippers and positioned such that the grippers can merely clamp the glass blanks, and then the further processing can be performed. This method variant has proved to be particularly quick. It is thus possible for the production of the rod-shaped glass blanks and the further processing resulting in bent glass bodies to be combined in an integrated method.

Furthermore, for the purpose of applying the inventive method, the invention also comprises a bending device for producing a bent glass body from a rod-shaped glass blank, having a data processing unit for controlling the bending operation, having at least a first and second gripper for clamping at least one glass blank at least two clamping sites, at least one gripper being movable, and having heating means for heating the bending region L₀, envisaged for the bend between the clamping sites.

An inventive development of the bending device is provided by virtue of the fact the heating means comprise at least one burner that, for the purpose of heating up the bending region L₀ can be moved up to and back from the clamped glass blank between the clamping sites of the grippers. It is thereby possible to achieve that the burner is moved up to the glass blank in order to heat up the region to be bent, and is removed from the glass blank again after the bending temperature has been reached. It is advantageously ensured in this case that the molding operation can be performed with the bending temperature remaining largely the same, it thereby being possible to ensure a high quality of the glass body thus produced. The bending region is free from heating elements during free bending, and so it is possible to bend freely in any direction.

Alternatively, the invention covers arranging the burner in a stationary fashion in the bending device and guiding the glass blank up to the burner by the grippers.

It has also proved to be advantageous to use more than one burner for heating up the bending region. It is thereby possible to reduce the heating up times and to achieve a more uniform heating up of the bending region.

It is also possible according to the invention to make use as heating means of other suitable heat generators, and so infrared radiators or inductive heating means or electrical heating plates can be used according to the invention.

Moreover, it is provided according to the invention that the rod-shaped glass blanks are fed to the bending device by means of a tracking apparatus, and that the bending device has means for successively or continuously tracking the glass blanks.

In the case of the method variant of successively fitting the bending device with glass blanks, it is expedient that the grippers have means for picking up the glass blanks from the tracking apparatus. According to the invention, the grippers are fastened for this purpose on arms, preferably robot arms, that move and position the grippers in accordance with the position of the glass blanks. It is also alternatively provided according to the invention that the glass blanks are removed from the tracking apparatus by means of a separate gripper arm, and are fed to the grippers for the bending operation. The means for successively or continuously tracking the glass blanks can also be fashioned according to the invention as special clamping jaws for holding glass rods, as additional grippers or else in the form of a conveyer belt. Combinations of these means are likewise covered by the invention.

It is alternatively provided that the bending device is equipped with means for transporting the glass blanks from the tracking apparatus, the glass blanks being guided to the grippers, and then being positioned and clamped.

For the purpose of positioning, sensor means can sense the respective positioning data of the glass blanks relative to the grippers and transmit them to the data processing unit, which calculates the corresponding control parameters for the grippers or the robot arms, transports means or the separate gripper arm, and prescribes them.

Moreover, the invention covers a bent glass body that is bent from a rod-shaped glass blank using the above-described method.

An advantageous embodiment has been found with a glass body by virtue of the fact that the glass blank has a diameter of at least 1 mm, preferably a diameter of between 5 mm and 10 mm.

It has emerged that the method can be used to produce bent glass bodies that have a substantially larger diameter than fiber systems and are thereby more cost effective than comparable flexible fiber systems (flexible light guides having a variety of individual fibers made from core glass and cladding glass) that are frequently provided with a protective cladding made from plastic, and for which bending strength is a parameter to be observed in the application. The glass body can be produced with a higher transmission or luminous efficiency by the inventive method. The inventive glass bodies can be used for various purposes, in particular for applications that in addition to the optical properties also require large dimensions conditioned by use in conjunction with appropriate material strength and rigidity and/or robustness. It is provided in this case according to the invention to bend rods at a length of up to 400 mm and with a diameter of up to 10 mm.

It has been found to be particularly advantageous that the glass body is designed as a light guide for transmitting light or images.

It is to be remarked that the use of the term light does not limit the inventive idea to light in the visible spectrum. Rather, the inventive glass bodies can generally also be used, in particular, in conjunction with electromagnetic radiation of any desired wavelength, for which reason the term light is to be understood in the scope of the invention as synonymous with electromagnetic radiation.

In a preferred embodiment, the rod-shaped glass body is formed by means of the inventive method from a single glass type (core glass) that dispenses with an optical cladding surrounding it that is made from a second glass type (cladding glass). Light is guided inside the unclad glass body formed from the unclad glass rod by total reflection at the glass/air interface. Since the difference of the refractive index of glass and air is particularly high, light is guided in this embodiment with particular efficiency and so the inventive method can also be used to produce inventive glass bodies having small bending radii that have particularly few light losses. A further advantage of the glass bodies in accordance with this embodiment is that their numerical apertures has the value 1. This means that light can fall on to the input surface of the glass body at very large incidence angles of up to 900 relative to the optical axis, can be guided nevertheless by said glass body. This property reduces a substantial outlay in the design and production of light sources whose systems, for example, focusing and reflectors, must otherwise be adapted to the numerical aperture of the light guides.

In an alternative embodiment, the glass body is formed from a glass rod made from a core glass that, by contrast with the previously described embodiment, has at least one cladding coating which is made from at least one cladding glass. The cladding is designed in such a way that the reflection of the light guided through the glass body takes place at the interface between the glass rod and the cladding glass. The cladding glass usually completely coats the core glass on its outer surface and has a lower refractive index than the core glass. Other refinement possibilities are, however, conceivable and are likewise covered by the invention, for example, the use of more than one cladding and/or changing cladding glass compositions. Moreover, it is also possible to provide special geometries of the glass rods and their claddings, for example, also polygonal cross sections in addition to round ones, and/or varying thicknesses of glass rod and cladding. By contrast with the unclad embodiment, the clad embodiment has the advantage that the light transmission is not impaired by instances of damage that adhere to the surface of the glass body and which in the case of the unclad glass body, disturb the total reflection at the air interface and can thus cause light to be coupled out of the glass body. However, it is a substantial advantage of the inventive method that even unclad glass bodies can be efficiently produced without critical instances of surface damage and instances of soiling.

In a further preferred embodiment, the glass body is formed from a fiber rod. A fiber rod can consist of one or more drawn glass rods and/or glass fibers that preferably consist at least of a core and a cladding coating it. The individual glass rods or glass fibers contained are frequently pressed with one another under the action of heat in order to produce fiber rods. A fiber rod thus obtained can subsequently be freely shaped with the aid of the inventive method.

It is particularly preferred for the abovenamed fiber rod to be surrounded by a buffer glass. The buffer glass does not fulfill an optical function but surrounds the fiber rod and seals any cavities present such that no substances such as liquids, gases or dirt particles can penetrate into the fiber rod. In addition to the mechanical stability, it is also possible in this way to increase the durability of the fiber rod in relation to environmental influences. The buffer glass can be applied by the inventive method before the deformation of the fiber rod, but also alternatively after the deformation.

If use is made of fiber rods that are made from a variety of individual glass rods or glass fibers which themselves have a core and a cladding and are arranged such that the matrix of the position of the light entrance ends corresponds to the matrix of the position of the light exit ends, the talk is of an ordered fiber bundle. Such ordered fiber bundles are suitable, in particular, for image transmission.

It is particularly preferred for the glass body to consist of one or more multicomponent glasses. What is meant by a multicomponent glass is a glass whose composition consists of more than one component. Examples of multi-component glasses suitable for fiber applications can be gathered from the commonly assigned Patent U.S. Pat. No. 7,072,562 B2 and it counterpart German patent DE 102 45 987 B3.

Alternatively, the glass body can consist of one or more single-component glasses. By contrast with the multicomponent glass, the composition of a single-component glass consists in essence of a sole component. The best known single-component glass is silica glass, which consists substantially of SiO₂.

Of course, it is possible to use not only single fibers of one type as starting material for the glass body precisely when using a fiber rod. Precisely when single fibers of respectively differing core and cladding glasses are arranged next to one another in a suitable way in a fiber rod, it is possible to match the optical properties of the fiber rod, thus also of the inventive glass body, in a targeted way. For example, it is possible for the fiber rod to focus light given an appropriate arrangement of single fibers of different refractive index. Defocusing arrangements are likewise possible. Moreover, the invention is not restricted to glass bodies that have the same cross sectional surfaces. It is likewise possible to use glass bodies that, for example, have a smaller light entrance surface by comparison with the light exit surface. Such a glass body can be used, for example, to illuminate a relatively large spatial volume with the aid of a relatively small light source, or to give the impression of a relatively large, and thereby optically more prominent light exit surface. If use is made of a relatively large light entrance surface by comparison with the light exit surface, the glass body acts as a light collector. If use is made as light source of, for example, a plurality of LEDs, the inventive light guide can collect the emitted light and cause it to emerge with high intensity from the light exit surface. The geometry of the light exit surface can be round and be freely selectable such that the inventive glass body can also be used as an element of an illuminating device of a vehicle, for example, of the headlamp. Of course, the geometry of the glass body can be combined with the abovementioned combination of the single fibers, for example, in order to produce specific optical effects.

In order to be able to achieve a far-reaching freedom in fashioning the systems in which the inventive glass body is installed, the glass body can, moreover, have varying cross sectional surfaces and cross sectional geometries.

In order to achieve a high mechanical stability, particularly when applying illumination with high light intensities, it is provided, furthermore, that the glass has, with particular preference, a coefficient of thermal expansion in the range of α<5·10⁻⁶·K⁻¹. In order to provide optimum conditions for a light guide, it has proved to be further advantageous that in the unbent state the glass of the glass blank has a transmission of more than 80% at 300 mm; that the glass has a high percentage purity, preferably being free from impurities with Fe ions; and that the glass is permanently thermally stable, preferably up to 400° C., as well as that the glass has high chemical durability, preferably containing a low or no fraction of alkalis.

It has been found in this case to be particularly suitable that the glass is a borosilicate glass having a coefficient of thermal expansion of approximately α=3.25·10⁻⁶·K⁻¹, and that the glass is a silica glass having a coefficient of thermal expansion of approximately α=0.5·10⁻⁶·K⁻¹.

Moreover, the two types of glass found have a high degree of purity. The Schott-Duran® glass, which has a very high chemical durability and a sufficiently good coefficient of thermal expansion, preferably comes into consideration as borosilicate glass for application in the abovedescribed method. The composition of Schott-Duran® is as follows, in percent by weight: SiO₂ 81%, B₂O₃ 13%, Na₂O and/or K₂O 4% and Al₂O₃ 2%. Its water resistance corresponds to Class 1 in accordance with DIN ISO 719 (98° C.), its acid resistance to Class 1 in accordance with DIN ISO 12 116, and its alkali resistance to Class 2 in accordance with DIN ISO 695.

The invention further covers a use of an inventive bent glass body in a motor vehicle having at least one illuminating device, which comprises at least one light generating lighting system and at least one light exit point, for transmitting light between the light generating lighting system and the at least one light exit point. The inventive glass body can thus be used as a light guide that guides light from the light source to any desired location of the light exit. The location of the light exit can be the light exit surface of the light guide itself, or else of a further optical system, for example, one or more lenses.

It has been recognized as advantageous in this case that the glass body is integrated, in a preferably modular fashion, in the lighting device of the motor vehicle.

It is thereby possible to avoid damage in the region of the illuminating device during mounting in and servicing of the vehicle.

Moreover, the invention covers the use of a bent glass body in an item of laboratory equipment or in an appliance for medical applications in order to transmit light or image information of the treatment site, the glass body being integrated in the item/appliance, preferably in a laryngoscope.

It is provided in this case according to the invention that the glass body has a shape of the bend that is adapted to the respective laboratory or medical application.

Advantages of the invention are, principally that the glass blanks can be bent in various planes with different bending radii and/or bending angles, and thus that glass bodies can be made available flexibly in a simple way and at relatively low cost. In particular, there is no need for molds. Consequently, the production time can be reduced, since there is no need either to exchange molds or to clean or service molds.

Furthermore, the parameters for producing the glass bodies can be set quickly and without material outlay on the data processing unit such that the method can be set up for variously shaped glass bodies without substantial setup time.

It is also advantageously possible to use the invention to improve the quality of the bent glass bodies, in particular their surface quality, since the free bending permits the bending region to remain untouched during the bending operation. That is to say, in the heated up state, the glass blank does not touch other materials. Mechanical damage owing to molds, also owing to clamping means, can thus be avoided. Consequently, as a result of the invention the surface of the region of the glass blank heated up to bending temperature remains substantially undamaged during free bending, and so the optical properties of the surface that are generated during production of the glass blank are likewise retained.

Other features which are considered as characteristic for the invention are set forth in the appended claims.

Although the invention is illustrated and described herein as embodied in a method and a device for forming bent glass bodies and in a glass body, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of the inventive device with a clamped glass blank, in two different bending states; and

FIG. 2 is a schematic sketch for illustrating the parameters involved in the molding operation.

### DETAILED DESCRIPTION OF THE INVENTION

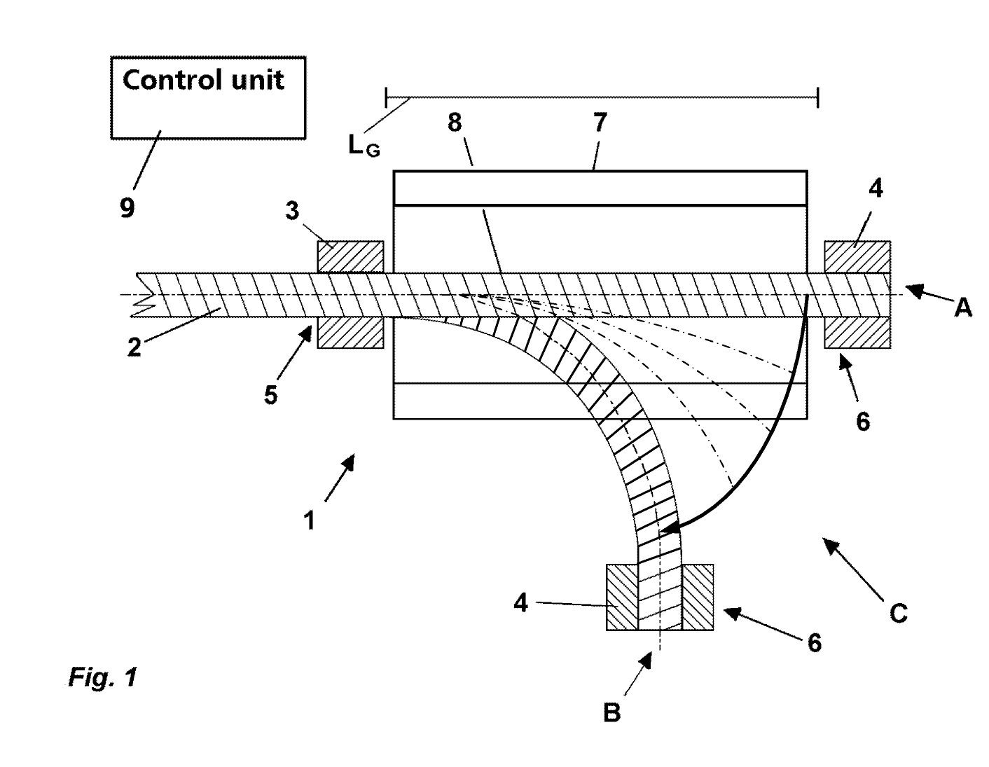

Referring now to the figures of the drawing in detail, FIG. 1 shows a schematic illustration of the inventive bending device 1, with a clamped glass blank 2 in two different states A and B. In the initial state A, the glass blank 2 is held unbent in the device 1. In the bending state B the glass blank 2 is bent.

The bending device 1 has two mutually corresponding grippers 3, 4. The grippers 3, 4 are spaced apart from one another at a predetermined spacing L_{G} and are fastened on the glass blank 2 at corresponding clamping sites 5, 6. A bending region L₀ is located between the grippers 3, 4. The bending region is selected to be smaller than the spacing distance L_{G} between the grippers. The spacing of the grippers 3, 4 or of the clamping sites 5,6 from the bending region L₀ to be heated up and/or to be bent depends on a temperature gradient of the glass material and can be prescribed as a parameter of a data processing unit (identified here as a “control unit”) 9.

The glass blank 2 is heated up to a bending temperature, for the purpose of bending, between the clamping sites 5, 6. For bending purposes, the gripper 4 can be moved at the clamping site 6 in a plane that lies in the plane of the drawing in the figure. At the clamping site 6, the glass blank 2 can thus be freely bent in relation to the corresponding clamping site 5.

In accordance with the inventive method the movable gripper 4 is moved on a bend path C in relation to the corresponding gripper 3, the bend path C being prescribed as a function of the final bending angle or the final bending radius. This can preferably be performed under the control of the processor 9. The data processing unit is illustrated highly diagrammatically.

The bending region of the glass blank 2 between the clamping sites 5, 6 is heated up to the prescribed bending temperature during a prescribed heating period. The heating is undertaken with the aid of suitable heating means 7.

The heating means 7 are arranged between the clamping sites 5, 6 in such a way that they can heat up the glass blank 2 in a longitudinal direction. In the design variant illustrated the glass blank lies between the two burners in a plane that remains free. It can thereby advantageously be achieved that the glass blank 2 can be heated up uniformly and quickly. After heating up is completed, the burners are moved away from the glass blank 2, and the glass blank 2 is subsequently bent. The bending operation can therefore be performed at a constant bending temperature. Other heating means such as, for example, electrical heating plates, infrared radiators or inductive heating means, are likewise conceivable and are covered by the invention.

The glass blank 2 held in the bending device 1 is firstly located in the initial state A, the grippers 3, 4 holding the glass blank 2. After the glass blank 2 has been brought up to the requisite bending temperature in the bending region 8 between the clamping sites 5, 6, the gripper 4 is moved for the purpose of bending. In this process, the gripper 4 travels on a bend path C in a fashion relative to the clamping site 5 of the glass blank 2, which is held by the gripper 3, such that the glass blank 2 is bent in the bending region 8. It is provided for this purpose, by the invention, that the bend path C is prescribed independently of the heating period or the bending temperature. Moreover, it is provided that the straight length L₀, which corresponds to the bending region 8, between the clamping sites 5, 6 is prescribed as a function of the final bending radius or the final bending angle.

The deformation operation is monitored according to the invention by an electronic data processing unit. In this process, the movement of the gripper 4 is controlled, and the heating up operation, particularly the heating period in this case is time controlled as a function of the bending temperature. The bending temperature results from the heating energy to be introduced into the bending region. In this case, the invention comprises the fact that the data processing unit can prescribe the bending temperature and heating period as well as the bending period, the final bending radius and the final bending angle under the control of the processor 9.

The glass blanks 2 can advantageously also be bent in the plane between the heating means 7. Moreover, the glass blanks can be bent freely in other planes as well. Different bending radii or bending angles can therefore advantageously be produced flexibly in a simple and cost-effective way by the free bending.

The inventive method and the relevant bending device 1 require no molds during bending, and so the costs for producing the glass bodies bent in accordance with the invention remain low. Again, the production time is substantially reduced by contrast with methods of the prior art, since there is no need either to exchange molds or to clean or service molds between the consecutive deformation operations in order to form different bending angles or bending radii. All that is required to this end is to prescribe the appropriate parameters to the data processing unit.

Moreover, the free bending renders it possible to bend the glass body produced from the glass blanks 2 in the heated-up bending region 8 without touching other materials, and so glass bodies of high quality can be produced, the surface of the bending region 8, heated up to bending temperature, of the glass blank 2 being preserved substantially undamaged during free bending and thus the optical properties of the glass body, in particular the transmission of light, being preserved.

In comparison with bending by means of molding the parameters of the bending device can be set quickly. The set up times of the bending device for free bending are short. Thus, glass blanks made from different glass materials and having various bends can be processed quickly in the bending device, the respective parameters being prescribed by the control unit 9.

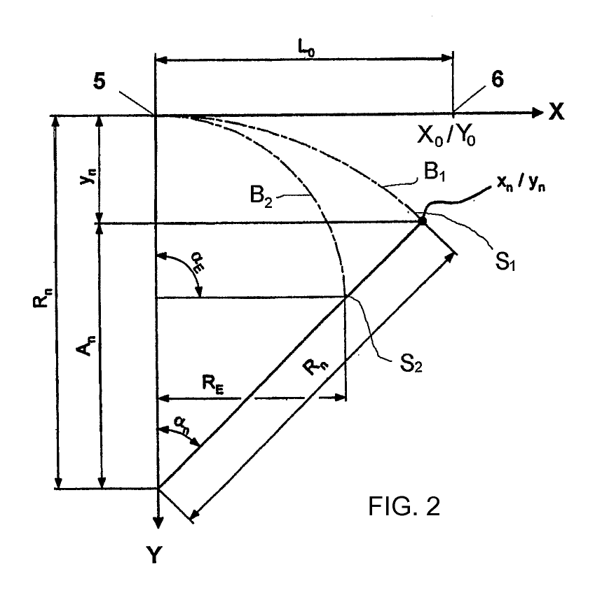

FIG. 2 constitutes a schematic sketch for illustrating the parameters that play a part in the molding operation.

The glass blank 2 is illustrated schematically in the initial state A as coordinate X in the direction along its longitudinal axis, and is bent in the direction of the coordinate Y, which lies perpendicular thereto. The dotted and dashed lines S₁ and S₂ represent the bent glass blank 2 in different bending states B₁ and B₂.

The spacing between the clamping sites 3, 4 on the glass blank 2 is L_{G} in the initial state A. L_{G} is not illustrated in the drawing. The bending region provided for the bend is presented as L₀.

The clamping site 6 on the bend path C is moved during bending. Starting from the initial point (X₀/Y₀), the bend path C extends via the bending state B₁ with the coordinates x_{N}/y_{N} up to the final bending state B₂.

During the deformation operation, the bending angle α changes from the initial angle α₀=0 up to the final bending angle α_{E}, the bend then having a final bending radius R_{E}.

In this case, L₀ is prescribed as a function of the final bending angle R_{E} in accordance with the formula:

L₀=2*R_{E}*π*α_{E}/360 °.

In this case, the bending radius Rₙ at the position αₙ is prescribed as follows:

Rₙ=(L₀/2*π)*360°/αₙ

it being possible to calculate xₙ=sin αₙ·Rₙ and yₙ=Rₙ−cos α_{n·R}ₙ correspondingly. αₙ is determined iteratively and prescribed.

1. A method for producing a glass body with at least one bend from a rod-shaped glass blank, the method which comprises the following automated method steps:
holding the glass blank in a bending device having at least two grippers mounted to be movable relative to one another, and clamping the glass blank with the grippers;
positioning the glass blank with a designated bending region L₀ between the first and second grippers;
heating the bending region L₀ to a bending temperature with heating means; and
subsequently freely bending the bending region L₀ by way of a mutual bending movement of the grippers.

2. The method according to claim 1, wherein the bending step comprises securing the glass blank at one end of the bending region L₀ with the first gripper and executing a bending movement with the second gripper acting at an opposite end of the bending region L₀.

3. The method according to claim 1, wherein the bending movement describes a bend path for producing the desired bend in the glass blank, and defining the bend path with a bending curve and an offset value for length compensation on the glass blank for each of the grippers respectively.

4. The method according to claim 1, which comprises simultaneously forming a plurality of bends on one glass blank in a bending device having more than two grippers and a plurality of heating means.

5. The method according to claim 1, which comprises forming a plurality of bends in temporally sequential bending operations on a glass blank in the bending device, and thereby repositioning the grippers after each respectively finished bending operation to a following bending region L₀.

6. The method according to claim 1, which comprises prescribing a bending curve for the grippers during bending as a function depending on at least one of a straight length of the bending region L₀, a final bending angle α_{E} to be reached, and a bending radius to be reached.

7. The method according to claim 1, which comprises heating the glass blank to a prescribed bending temperature during a prescribed heating period.

8. The method according to claim 7, which comprises heating the glass blank as a function of a glass volume to be heated and/or a glass rod diameter.

9. The method according to claim 1, which comprises prescribing at least one of a heating period and a bending temperature with a data processing unit as a function of a glass material and a diameter of the glass blank.

10. The method according to claim 1, which comprises positioning the grippers to act on the glass blank at a mutual spacing distance L_{G}>L₀.

11. The method according to claim 1, which comprises successively removing the glass blanks with the grippers from a feeding apparatus and subsequently bending the glass blanks.

12. The method according to claim 1, which comprises continuously introducing the glass blanks into the bending device.

13. A bending device for producing a bent glass body from a rod-shaped glass blank, comprising:
a data processing unit for controlling a bending operation;
a plurality of grippers, including at least a first gripper and a second gripper, for clamping at least one glass blank at least two clamping sites;
wherein at least one of said grippers is movably disposed; and
heating means for heating a bending region L₀ for a proposed bend in the glass blank between the at least two clamping sites.

14. The bending device according to claim 13, wherein said heating means includes at least one burner for heating up the bending region L₀ movably disposed for moving towards and away from the clamped glass blank between the clamping sites of said grippers.

15. The bending device according to claim 13, which comprises a tracking apparatus for feeding the rod-shaped glass blank to the bending device and wherein said bending device includes means for successively or continuously feeding the glass blanks.

16. A bent glass body formed from a rod-shaped glass blank by bending the rod-shaped glass blank with a method according to claim 1.

17. The bent glass body according to claim 16, wherein the glass blank has a diameter of at least 1 mm.

18. The bent glass body according to claim 17, wherein the glass blank has a diameter of between 5 mm and 10 mm.

19. The bent glass body according to claim 16, wherein the glass body is configured as a light guide for transmitting light or images.

20. The bent glass body according to claim 16, wherein the glass body is formed from an unclad glass rod.

21. The bent glass body according to claim 16, wherein the glass body is formed from a glass rod made from a core glass and coated with at least one cladding made from at least one cladding glass.

22. The bent glass body according to claim 16, wherein the glass body is formed from a fiber rod.

23. The bent glass body according to claim 22, wherein said fiber rod consists of a plurality of fibers each with a core made from at least one core glass and coated with at least one cladding made from at least one cladding glass.

24. The bent glass body according to claim 22, wherein said fiber rod is surrounded by at least one buffer glass.

25. The bent glass body according to claim 16, wherein the glass body consists of one or more multi-component glasses.

26. The bent glass body according to claim 16, wherein the glass body consists of a single-component glass.

27. The bent glass body according to claim 26, wherein the glass has a coefficient of thermal expansion of substantially α<5·10⁻⁶·K⁻¹.

28. The bent glass body according to claim 16, wherein, in an unbent state, the glass of the glass blank has a transmission of more than 80% at 300 mm.

29. The bent glass body according to claim 16, wherein the glass is a highly pure glass.

30. The bent glass body according to claim 29, wherein the glass is a high-purity glass substantially free from impurities with Fe ions.

31. The bent glass body according to claim 16, wherein the glass is permanently thermally stable.

32. The bent glass body according to claim 16, wherein the glass is permanently thermally up to a temperature of 400° C.

33. The bent glass body according to claim 16, wherein the glass has high chemical durability.

34. The bent glass body according to claim 16, wherein the glass contains a low fraction or no fraction of alkalis.

35. The bent glass body according to claim 16, wherein the glass is a borosilicate glass.

36. The bent glass body according to claim 16, wherein the glass is a silica glass.

37. In a motor vehicle having at least one illuminating device, a bent glass body according to claim 16, the bent glass body being disposed to transmit from the light generating lighting system and at least one light exit point.

38. The combination according to claim 37, wherein the glass body is integrated in the lighting device of the motor vehicle.

39. In combination with an item of laboratory equipment or with an appliance for medical applications, a bent glass body according to claim 16 disposed to transmit light or image information of a treatment site, the glass body being integrated in the laboratory equipment or the appliance.

40. The combination according to claim 39, wherein the appliance is a laryngoscope having the glass body integrated therein.

41. The bent glass body according to claim 16, configured to form an item of laboratory equipment or an appliance for medical applications and to transmit light or image information at a treatment site.

42. The bent glass body according to claim 41, wherein the glass body is configured as a laryngoscope.

43. The bent glass body according to claim 41, wherein the glass body is shaped with a bend adapted to a respective laboratory or medical application.
